(19) United States
(12) Patent Application Publication
(10) Pub. No.: US 2006/0227490 A1
(43) Pub. Date: Oct. 12, 2006

(54) Electronic drive circuit for an impulse-controlled actor

(75) Inventors: Michael Bolz, Welzheim (DE); Martin Prokscha, Schwaebisch Gmuend (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/399,102

(22) Filed: Apr. 6, 2006

(30) Foreign Application Priority Data
Apr. 12, 2005 (DE) 10 2005 016 826.4

(51) Int. Cl. H01H 47/18; B60R 21/16; B60R 21/26

(52) U.S. Cl. 361/196; 280/735; 280/741

(57) ABSTRACT

An electronic drive circuit for an impulse-controlled actor (10) comprises a first capacitor and a first thyristor (24). The first thyristor (24), after its ignition, permits a discharging of the first capacitor (18) via the actor (10).

### TECHNICAL FIELD

The invention relates to an electronic drive circuit for an impulse-controlled actor.

### BACKGROUND OF THE INVENTION

In many devices relating to safety for vehicle occupant restraint systems, controlling- and/or switching processes take place which necessitate a particular energy requirement. To reduce this energy requirement and to shorten the switching times, impulse-controlled actors can be provided. Such actors are controlled with short current impulses; a continuous current to maintain a state is not necessary. The required switching power is thereby distinctly reduced.

In an electronic drive circuit for an impulse-controlled actor, care is to be taken that the generated impulses are matched to the design of the actor in order to ensure a correct operation of the actor and hence of the device relating to safety. For example, in a bistable lifting magnet, a continuous current or current impulses which are too long could lead to damage owing to thermal overload.

The invention provides a favourably priced electronic drive circuit for an impulse-controlled actor, with which a faulty operation of the actor can be largely ruled out.

### BRIEF SUMMARY OF THE INVENTION

According to the invention, an electronic drive circuit for an impulse-controlled actor comprises a first capacitor and a first thyristor. The first thyristor, after its ignition, permits a discharging of the first capacitor via the actor. The discharging of the capacitor provides for a suitable current impulse, without a time-controlled application of a voltage to the actor being necessary. With a given voltage source, the capacitor can be coordinated precisely to the requirements of the actor. Furthermore, the invention advantageously utilizes the particular characteristics of a thyristor. In the circuit according to the invention, the thyristor is used such that it causes the discharging of the capacitor via the actor through its ignition. Thereby, a timed rapid emission of a current impulse is made possible. After the discharging of the capacitor, no more current flows through the thyristor, such that the latter blocks automatically.

Preferably, the electronic drive circuit according to the invention further comprises a second capacitor and a second thyristor. The second thyristor, after its ignition, permits a discharging of the second capacitor via the actor. The flow of current upon discharge of the second capacitor is opposed to the flow of current upon discharge of the first capacitor. With such a circuit, positive and negative impulses can be emitted to the actor. This is necessary in bistable lifting magnets, in order to alternate between the two stable states.

According to a particular further development of the invention, the electronic drive circuit comprises a third capacitor. The discharging of the third capacitor causes an ignition of the second thyristor. The third capacitor is connected such that a discharging of the first capacitor causes a charging of the third capacitor.

### BRIEF DESCRIPTION OF THE DRAWINGS

FIGS. 1a, 1b show a bistable lifting magnet in a first position and in a second position, respectively;

FIG. 2 shows a circuit diagram of the electronic drive circuit according to the invention; and

FIG. 3 shows the voltage curve on two components of the circuit of FIG. 2.

### DETAILED DESCRIPTION OF THE PREFERRED EMBODIMENTS

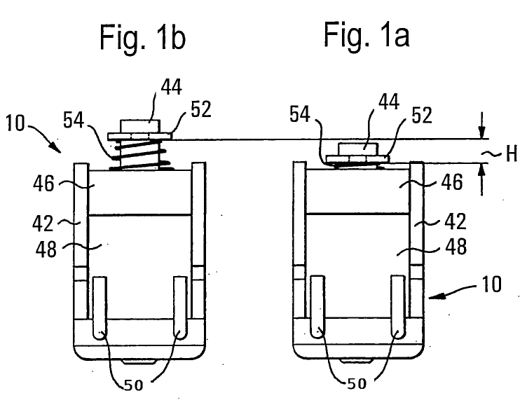

In FIGS. 1a and 1b a bistable lifting magnet 10 is illustrated, which is used as an actor in a safety device of a vehicle occupant restraint system. The bistable lifting magnet 10 has a housing 42 and a plunger 44 which is guided so as to be linearly displaceable. A permanent magnet 46 and a coil 48 are arranged in the housing 42 which is approximately 1 cm in size. The coil 48 can be provided with current via connection lines 50. A compression spring 54 is arranged on the plunger 44 between a support surface 52 of the outer end of the plunger 44 and the housing 42.

The bistable lifting magnet 10 has two stable end positions, namely with the plunger 44 retracted (FIG. 1a) and with the plunger 44 extended (FIG. 1b), which are designated below as the first position and the second position, respectively. The first position is stable owing to the force of attraction between the plunger 44 and the permanent magnet 46; the second position is supported by the compression spring 54. The stroke H of the plunger 44 amounts to approximately 2 mm.

The bistable lifting magnet 10 is controlled via short current impulses which are generated by the electronic drive circuit according to the invention, which is explained later in more detail. In order to move the bistable lifting magnet 10 from the first position to the second, a current must be applied briefly to the coil 48 in a direction inducing a magnetic field which neutralizes the magnetic field of the permanent magnet 46 and exerts a repelling effect on the plunger 44. The force of the compression spring 54 in the second position serves as a holding force for the plunger 44, which is greater than the permanent magnet force of attraction occurring again after the current impulse. A current impulse in the opposite direction induces a magnetic field which is equidirectional to the magnetic field of the permanent magnet 46. In this case, the force of attraction is sufficient to overcome the holding force of the compression spring 54, such that the plunger 44 is retracted into the first position again.

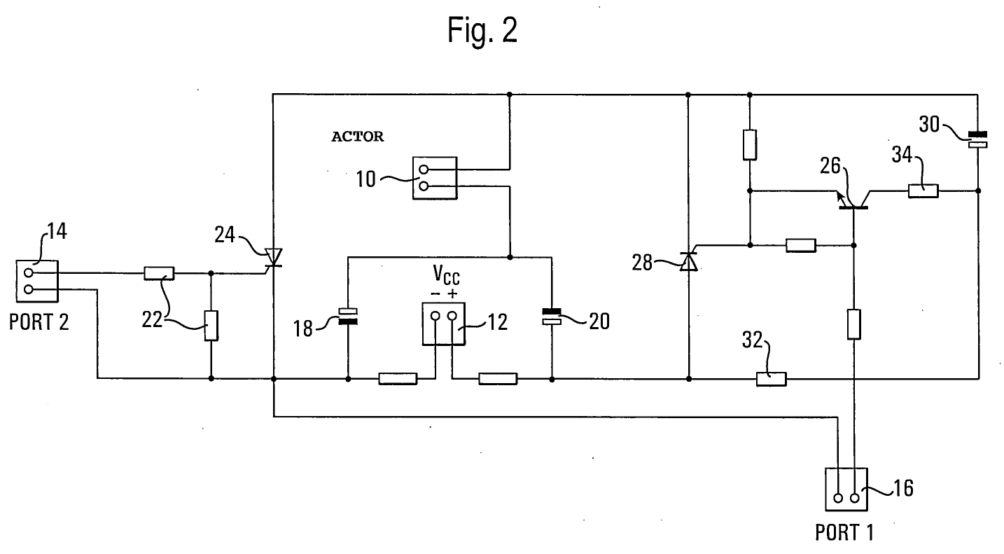

In FIG. 2 a circuit diagram is shown of the electronic drive circuit according to the invention for the bistable lifting magnet 10. The circuit comprises a voltage source 12 and two control inputs 14, 16 (Port 1 and Port 2), via which control signals are fed in. A logic part, which is not illustrated, makes provision that a high signal is emitted at Port 2 when the bistable lifting magnet 10 is to be transferred from the first position into the second position. A high signal is emitted at Port 1 for a transfer of the bistable lifting magnet from the second position into the first position.

The mode of operation of the electronic drive circuit is described below.

The voltage source 12, providing a supply voltage V_{cc}, charges a first capacitor 18 and a second capacitor 20. At a moment t=0, a high signal is emitted via the Port 2 to the gate of the first thyristor 24 via the voltage divider 22. At the same time, the control signal of Port 1 is low; the transistor 26 is blocking and the voltage at the gate of the second thyristor 28 is 0. The first thyristor 24 ignites and allows the discharging of the first capacitor 18 via the actor (load) to the anode of the first thyristor 24. The first thyristor 24 remains conducting until the first capacitor 18 has discharged. After this, the first thyristor 24 is blocking again.

In the load circuit, an exponentially fading current flows accordingly in a positive direction, which is sufficient to move the plunger 44 of the bistable lifting magnet 10 from the first position into the second position. The switching time amounts to approximately 16 ms.

The igniting of the first thyristor 24 additionally causes a shift of the electric potentials at the cathode of the second thyristor 28 and of the third capacitor 30 to −12 V (negative supply voltage V_{cc} of the voltage source). This leads automatically to a charging of the third capacitor 30 via the charging resistance 32, the charging time amounting to approximately 150 ms.

Subsequently, if required, a signal change can take place at the control inputs 14, 16, in order to retract the plunger 44 of the bistable lifting magnet 10. In this case, the logic part of the circuit makes provision that a high signal is emitted at Port 1, whilst the control signal at Port 2 is low. The transistor 26 is driven through, such that the third capacitor 30 discharges via the resistance 34 onto the gate of the second thyristor 28 and ignites the latter. In the meantime, the first thyristor 24 is blocking again owing to the previous discharge of the first capacitor 18. The igniting of the second thyristor 28 therefore leads to a discharge of the second capacitor 20 via the actor.

An exponentially fading current now flows in the load circuit in a negative direction, which is sufficient to move the plunger 44 of the bistable lifting magnet 10 from the second position into the first position.

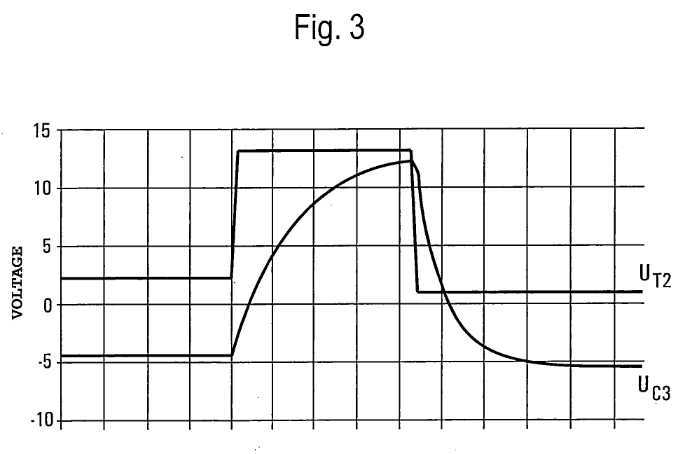

FIG. 3 shows the voltage curve at the second thyristor 28 and at the third capacitor 30.

A particular advantage of the electronic drive circuit according to the invention lies in the intrinsic security of the switching arrangement. Even if an error occurs in the logic part (software errors or the like), it is ensured that the actor is only operated with current impulses but never with a continuous current.

1. An electronic drive circuit for an impulse-controlled actor, the electronic drive circuit comprising a first capacitor and a first thyristor, the first thyristor, after its ignition, permitting a discharging of the first capacitor via the actor.

2. The electronic drive circuit according to claim 1, further comprising a second capacitor and a second thyristor, the second thyristor, after its ignition, permitting a discharging of the second capacitor via the actor, the flow of current upon the discharging of the second capacitor being opposed to the flow of current upon the discharging of the first capacitor.

3. The electronic drive circuit according to claim 2, further comprising a third capacitor, the discharging of the third capacitor causing an ignition of the second thyristor, the third capacitor being connected such that a discharging of the first capacitor causes a charging of the third capacitor.

4. The electronic drive circuit according to claim 1, further comprising two separate control inputs.
